(19) United States
(12) Patent Application Publication
(10) Pub. No.: US 2002/0087549 A1
(43) Pub. Date: Jul. 4, 2002

(54) Data transmission

(76) Inventor: Miraj Mostafa, Tampere (FI)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/990,359

(22) Filed: Nov. 23, 2001

(30) Foreign Application Priority Data
Nov. 22, 2000 (FI) 20002566

(51) Int. Cl. G06F 7/00

(52) U.S. Cl. 707/10

(57) ABSTRACT

A multimedia messaging method comprising the steps of:

receiving a content from a sender and addressed to one or more recipient;

accessing a database comprising recipient data describing multimedia reception capabilities and/or reception preferences for at least one recipient;

forming, in accordance with said recipient data, a notification message containing information that said media content is available to be streamed to the addressed recipient(s); and

transmitting the notification message to the addressed recipient(s). A corresponding network entity, communication system and computer program are also described.

This invention relates to data transmission.

### BACKGROUND OF THE INVENTION

In mobile communications networks, the term Multimedia Messaging Service (MMS) is commonly used to describe a new approach for transmitting messages having multimedia content. The Multimedia Messaging Service allows messaging between different mobile users and/or between mobile users and the Internet. There is an already agreed solution for providing an MMS in 3^{rd} Generation mobile communication networks and its features are described in 3^{rd} Generation Partnership Project (3GPP) technical specification 23.140 V.3.0.1. “Multimedia Messaging Service (MMS), Functional Description, Stage 2 (Release 1999)”. The Multimedia Messaging Service proposed in 3GPP 23.140 employs a store-and-forward approach to message delivery. Multimedia messages are constructed in such a way that the media content, information necessary to describe the media content and addressing information, identifying the intended receiver of the message, are encapsulated together. The multimedia message is then sent to a Multimedia Messaging Service Centre MMSC, which in turn notifies the receiver about the message. The multimedia message is downloaded by a recipient (typically by a multimedia terminal) as a whole and only presented to the user once downloaded and stored in the receiving terminal.

It should be appreciated that although the term “multimedia message” is used generally to describe an electronic message that contains more than one type of media content, in the context of the description provided in this application, the term extends to cover messages that contain only one media type.

The MMS solution according to currently accepted recommendations will now be described with reference to FIGS. 1 and 2.

FIG. 1 shows a typical arrangement of a Multimedia Messaging System according to prior art. In connection with FIG. 1, and throughout this application, the term MMSE (Multimedia Messaging Service Environment) is used as a collective term to describe the functional elements that operate together to implement a multimedia messaging service. In the example of FIG. 1, the MMSE is shown to comprise an MMS relay and an MMS server which, in this example, are integrated into a single unit, commonly referred to as a Multimedia Messaging Service Centre (MMSC). The MMS server is connected to a message store, in which messages arriving at the MMSC and addressed to a particular MMS subscriber are temporarily stored. The MMS relay is linked to a database comprising, for example, user subscription and addressing information. The MMS relay is also shown to be linked with two mobile telecommunication networks. The different telecommunication networks may, for example, have different operators, different geographical locations or coverage areas and/or differ in terms of their technical characteristics. For example, they may belong to different technical generations such as GSM and UMTS. Naturally, the number of networks with which the MMS relay may be connected is not limited to two. As shown in FIG. 1, each of the mobile telecommunication networks comprises one or more MMS user agents (UA). The MMS user agents may be, for example, GPRS terminals with software providing the MMS, or any other suitably equipped terminal. Communication between the MMSE and a particular User agent in a given mobile network takes place via the radio interface of the mobile network in question. FIG. 1 also shows a connection between the MMS relay and an IP network, for example the Internet. This connection enables a User agent resident in a mobile network to e.g. receive multimedia messages from an electronic mailbox connected to the IP network or to exchange multimedia messages with a user (e.g. an e-mail client) in the IP network. The IP connection may also serve as a link, coupling the MMS relay to a third mobile telecommunication network, which also has access to one or more MMS user agents.

FIG. 2 shows MMS architecture elements of a prior art system comprising two MMS Environments (MMSE), which are assumed to be under the control of different Service Providers. For clarity, each MMSE is shown to comprises a single MMS user agent, but it should be appreciated that typically a large number of such User agents will be present. Both MMSEs further comprise a mobile telecommunication network (MNW), an MMS Relay and an MMS server. The MMS Relays are coupled together to communicate using the SMTP protocol (SMTP, Simple Mail Transfer Protocol). The MMS Relays are also coupled with respective MNWs and with respective MMS servers in the same MMSE.

Next, the operation of the systems illustrated in FIG. 2 is described. An originating MMS user agent UA, here assumed to be MMS user agent A of MMSE A wishes to send some media content to MMS user agent B of MMSE B. MMS user agent A sends the media content (e.g. a video clip with voice) and all other related information encapsulated in a multimedia message to MMS Relay A through MNW A. If the recipient MMS user agent were in the same MMSE, MMS Relay A would store the media content in MMS server A and send a notification to the recipient MMS user agent. Upon receiving the notification, the recipient MMS user agent would retrieve the media content from the server via the MMS Relay. Retrieval of the media content is initiated by signalling with the MMS Relay A. However, if the intended recipient resides in another MMSE (e.g. the recipient is the MMS user agent B in MMSE B), MMS Relay A forwards the multimedia message to MMS Relay B. MMS Relay B stores the media content in MMS server B and sends a notification to the recipient MMS user agent B. In response to receiving the notification, MMS user agent B retrieves the media content from (via) the MMS Relay B. The retrieval of the media content is initiated by signalling with MMS Relay B. This occurs at the instigation of the receiving user agent.

Regardless whether the sender and recipient are in the same MMSE, the originating MMS user agent can be provided with a delivery report and/or a read-reply report to describe the status of the delivery and the opening of the multimedia message.

Streaming is a technique that could enhance multimedia messaging in many ways. The term “streaming” is generally used to describe the presentation of a media stream, for example an audio or video stream, or a combination of different streams, in a continuous way while those streams are being transmitted to a recipient over a data network. A “stream” can be, for example, a flow of data typically enabling the recipient to present some continuous data such as motion pictures (i.e. video), voice or music. In a typical video stream, some 10 to 20 video frames are transmitted per second. In practice, streaming can be either live (real- time) or performed in an on-demand fashion. The term “live streaming” describes the creation of a media stream from a live source, for example a stream of digital images produced by a video camera, while the term “on-demand streaming” describes the creation of a media stream from, for example, a file stored on a server.

The application of streaming in mobile networks looks very promising, especially considering the fact that mobile terminals typically have limited multimedia playing resources such as memory and processing power. Adoption of a streaming approach to media download and presentation has the potential to reduce the amount of available memory required by mobile terminals. The use of streaming would also be advantageous when multicasting media content to a number of recipients.

However, the encapsulation of media content, message description and addressing information in a single entity as proposed in current MMS specifications is incompatible with the streaming of media content. In order to establish a streaming session, it is necessary for the receiving terminal to be aware, in advance, of certain information relating to the media content. Such information includes, but is not limited to, the type of media contained in the message, the way that media is encoded and a suitable transport protocol that could be used to download the media content. Because current MMS specifications require information describing the media content to be encapsulated with the multimedia message itself, the receiving terminal cannot obtain prior knowledge about the properties of the media content and therefore cannot establish any form of streaming session. Thus, according to the present recommendations, the entire message must be downloaded to the receiving terminal in order for the details of the media content to be extracted. Only then can any media content, such as video and/or audio clips be played to the user of the receiving terminal. This limits the usability of the known MMS solution because multimedia clips are usually bulky in terms of bits and therefore a receiving terminal, for example a mobile station, would require a comparatively large available memory. The need to download an entire message before it can be presented may also give rise to significant delays in certain conditions, for example if the message is very large, or the data transmission rate of the connection is low.

One proposal, describing a way in which streaming functionality can be incorporated into a Multimedia Messaging Service, is presented in Finnish patent application Fl 2000 1741. Fl 2000 1741 suggests the provision of an end-to-end notification to provide a recipient MMS user agent (UA) with information required to establish a streaming session for downloading media content.

An MMS user agent has no means of knowing the exact capabilities of other UAs, and thus, a UA-generated notification might not serve the purpose in many cases, especially in the case of an inter-MMSE (MMS Environment) situation. Furthermore, such an end-to-end notification uses radio resources at both the sender's and recipient's end, consuming radio resources at both ends. Moreover, considerable changes may be necessary to the existing (non-streaming) MMS solution in order to support end-to-end notifications as proposed in Fl 2000 1741. A new notification message type should be defined and then the MMSE should be modified to deal with exchanging the new notifications between the originating MMS user agent and its MMS Relay, and between the MMS Relay and the MMS Relay of the recipient. It is important to limit the changes required in the existing practice of providing both the services of streaming and MMS separately. It is also important in this regard to minimise the transmission of information over the wireless interface to make efficient use of the scarce and expensive resource, radio link bandwidth. Flexibility is also very important in this regard to take into account different use cases, user-demands and telecommunication network infrastructures.

### SUMMARY OF THE INVENTION

According to a first aspect of the invention, a method is provided in a network entity comprising the steps of:

receiving media content from a sending entity and addressed to at least one recipient;

accessing a database comprising recipient data describing multimedia reception capabilities and/or reception preferences for at least one recipient;

forming, in accordance with said recipient data, a notification message containing information that said media content is available to be streamed to said at least one addressed recipient; and

outputting the notification message for transmission to said at least one addressed recipient.

Advantageously, by adopting this method, an existing multimedia messaging system can be relatively easily and cheaply complemented with streaming functionality, allowing streamed reception of media content to said at least one addressed recipient. Even more advantageously, in a case where more than one recipient is addressed, the possibility of providing streamed delivery reduces the required storage resources of the communication system, because the same content is stored once but used a multiplicity of times.

Preferably, the method further comprises the steps of:

receiving the media content in a multimedia messaging server; and

providing the at least one addressed recipient with the media content via the network entity;

wherein the network entity is a multimedia messaging relay.

The multimedia messaging server provides flexibility to a communication system and can be easily upgraded. It can be upgraded by providing additional mass memory if its storage capacity becomes insufficient, or by replacing it with a faster device if it becomes a bottleneck. On the other hand, the server can be initially dimensioned in such a way as to be capable of handling a relatively small amount of data so that the communication system's initial set-up is inexpensive.

Preferably, the media content comprises a set of different types of components and each component may be formatted in one or more formats.

Preferably, the method further comprises the following steps before said providing of the media content:

checking the format of at least one component of the received media content;

determining by using the recipient data whether the format is appropriate for said at least one addressed recipient; and

if necessary, translating the component into a format appropriate for said at least one addressed recipient.

Advantageously, the media content is translated if necessary into an appropriate format, so that typically no regeneration or conversion of the media content is required at the sending entity. Thus, retransmission of the content from the sending entity can also be avoided. This feature has the advantage of saving data transmission resources in the communication system, as the media content need not be retransmitted and received again at said network entity. This is particularly advantageous, if the sending entity is a terminal of a mobile telecommunication network, in which case retransmission of the media content would waste radio transmission capacity.

Preferably, a streaming session is established in order to stream at least some of the media content to said at least one recipient.

Preferably, when the media content is translated, it is translated while it is being streamed to said at least one recipient. By translating the media content into an appropriate format while it is being streamed, unnecessary translation can be avoided. This provides a particular advantage in situations where streaming may be interrupted, or is not started at all. If the media content were translated in its entirety before streaming were started, in such situations some or all of the of the translations would be performed in vain, unnecessarily consuming processing capacity and/or memory.

Alternatively, said media content is first translated into said appropriate format and then streamed to said at least one recipient. This allows performing at least part of the translation process during off-peak times, when fewer operations are pending and more processing capacity is available.

Preferably, the network entity is adapted to translate the media components between at least two different formats. Even more preferably, it is adapted, or it is arranged in such a way that it can be adapted to translate the media components between all necessary formats in order to allow reception and playing back of the media content by said at least one addressed recipient. In the latter case, the media content can be relayed to said at least one addressed recipient regardless of the format in which it was transmitted from the sending entity.

Preferably, said establishing of the streamed session is preceded by transmitting a notification to said at least one addressed recipient.

Preferably, said notification message provides a minimum amount of information necessary for said at least one addressed recipient to establish a streaming session with the said network entity.

Alternatively, said notification message comprises all necessary information for said at least one addressed recipient to establish a streaming session with said network entity. This allows the streaming session to be established without a need for further messaging to separately gather some of the necessary information.

Preferably, the method further comprises transmitting the notification message to said at least one addressed recipient via a first telecommunication network.

Preferably, said notification message is formed taking into account the properties of the first telecommunication network. Preferably, said properties of the first telecommunication network comprise at least one of the following: the network's multimedia transmission capabilities, the network's traffic condition, the availability of processing resources in the network. In this way, more effective streaming of media content and usage of the communication system's resources can be achieved.

Preferably, said streaming session is formed with said network entity at the instigation of said at least one addressed recipient.

Preferably, the notification message is formed and transmitted only if, according to the recipient data, said media content is of a format compatible with said at least one addressed recipient. This reduces transmission of redundant information.

Advantageously, the appropriateness of the content received at the network entity is checked before its transmission to the at least one addressed recipient. This avoids unnecessary data transmission, since inappropriate content need not be notified.

Alternatively, if said media content is incompatible with the recipient data maintained in the database, a first failure message indicating availability of inappropriately formatted media content is formed and transmitted to said at least one addressed recipient. This improves usability, as a user or users of said at least one addressed recipient is made aware of the failure in transmitting the media content.

Preferably, a second failure message is formed and transmitted to the sending entity to acknowledge incompatibility between the media content's format and the addressed recipient. Preferably, the second failure message is supplemented by an indication of an appropriate format. This helps the sending entity to re-send the media content in an appropriate format without first negotiating it with the network entity.

Advantageously, maintaining recipient data at the network entity allows early and accurate checking of the appropriateness of the media content. In this way, the transmission of a notification message to a recipient for which the media content is inappropriate is avoided. Network resources are thus conserved.

Alternatively, the method allows a streaming session to be established at the instigation of the network entity. In this way, a streamed session for transmitting the media content can be established without first messaging with the addressed recipient in two directions. Hence, data transmission bandwidth can be conserved in both directions on a radio link between the addressed recipient and the first telecommunication network. This kind of automatic establishment of a streaming session is useful when the user's desire to receive the content is already known, for example when the user has formerly ordered the content himself.

Preferably, said streaming session is established in a manner independent of the manner in which media content is received at said network entity. It is a further advantage of the invention, that the reception of media content can be carried out in any manner according to a decision made by one or both of the network entity and the addressed recipient. The decision is not bound by the manner in which the media content is made available to the network entity. In this way, streaming of media content may be implemented flexibly and without dependence on properties of any earlier phases preceding the receiving of said media content by the addressed recipient.

Alternatively, the streaming session established by said at least one recipient is dependent on the manner in which media content is received at said network entity. In this way end-to-end streaming of media content can be enabled.

Preferably, the method further comprises providing a radio link during communicating with the addressed recipient.

Advantageously, the method reduces the amount of redundant signalling/notification information it is necessary to transmit over the radio link.

Preferably, said sending entity is chosen from a group consisting of: a media storing entity of the first telecommunication network, a media storing entity of a second telecommunication network, a media storage in an external data transmission network, and a multimedia terminal of the first telecommunication network.

In an alternative embodiment of the invention, the media content is provided to said sending entity from a multimedia terminal in either a second or the first telecommunication network.

In an embodiment of the invention, the first and second telecommunication networks are under the control of different operators.

In an embodiment of the invention, the first and second telecommunication networks have different multimedia transmission capabilities.

Advantageously, the method may be implemented on top of an existing multimedia messaging service (MMS) system.

Preferably, said database is co-located with the network entity. Even more preferably, said database and network entity are integrated into the same unit.

Preferably, each of the at least one addressed recipient is dealt with separately. For example, each addressed recipient may have different capabilities, and the streaming sessions may be established at different times and media content streamed in different formats.

According to a second aspect of the invention, a network entity is provided comprising:

means for receiving a media content from a sending entity and addressed to at least one recipient;

means for accessing a database comprising recipient data describing multimedia reception capabilities and/or reception preferences for the at least one addressed recipient;

notification means for forming, in accordance with said recipient data, a notification message containing information that said media content is available to be streamed to said at least one addressed recipient; and

outputting means for outputting the notification message for transmission to said at least one addressed recipient.

According to a third aspect of the invention, a communication system is provided, comprising:

at least one recipient;

a network entity;

means for receiving media content from a sending entity and addressed to said at least one recipient;

means for accessing a database comprising recipient data describing multimedia reception capabilities and/or reception preferences for the at least one addressed recipient;

notification means for forming, in accordance with said recipient data, a notification message containing information that said media content is available to be streamed to said at least one addressed recipient; and

outputting means for outputting the notification message for transmission to said at least one addressed recipient.

According to a fourth aspect of the invention, a computer program is provided for controlling a network entity, comprising:

computer code for causing the network entity to receive media content from a sending entity and addressed to at least one recipient;

computer code for causing the network entity to access a database comprising recipient data describing multimedia reception capabilities and/or reception preferences for the at least one addressed recipient;

computer code for causing the network entity to form, in accordance with said recipient data, a notification message containing information that said media content is available to be streamed to said at least one addressed recipient; and

computer code for causing the network entity to output the notification message for transmission to said at least one addressed recipient.

According to a fifth aspect of the invention, a computer program product is provided comprising:

computer code for causing a network entity to receive a media content from a sending entity and addressed to at least one recipient;

computer code for causing the network entity to access a database comprising recipient data describing multimedia reception capabilities and/or reception preferences for the at least one addressed recipient;

computer code for causing the network entity to form, in accordance with said recipient data, a notification message containing information that said media content is available to be streamed to said at least one addressed recipient; and

computer code for causing the network entity to output the notification message for transmission to said at least one addressed recipient.

According to a sixth aspect of the invention a memory media is provided, comprising:

computer code for causing a network entity to receive media content from a sending entity and addressed to at least one recipient;

computer code for causing the network entity to access a database comprising recipient data describing multimedia reception capabilities and/or reception preferences for the at least one addressed recipient;

computer code for causing the network entity to form, in accordance with said recipient data, a notification message containing information that said media content is available to be streamed to said at least one addressed recipient; and

computer code for causing the network entity to output the notification message for transmission to said at least one addressed recipient.

The various embodiments of the present invention have been illustrated only with reference to the first aspect for sake of briefness, but one should appreciate that corresponding embodiments apply to the other aspects as well.

### BRIEF DESCRIPTION OF THE DRAWINGS

The invention will now be described, by way of example only, with reference to the accompanying drawings, in which:

FIG. 1 illustrates architectural elements of a Multimedia Messaging Service Environment;

FIG. 2 shows interworking between different MMSEs;

FIG. 3 illustrates the generation of a notification message at a recipient MMS relay according to a preferred embodiment of the invention;

FIG. 4 illustrates signalling performed in an MMSE according to an embodiment of the invention; and

FIG. 5 is a block diagram showing the basic structure of an MMSC according to an embodiment of the invention.

### DETAILED DESCRIPTION OF THE INVENTION

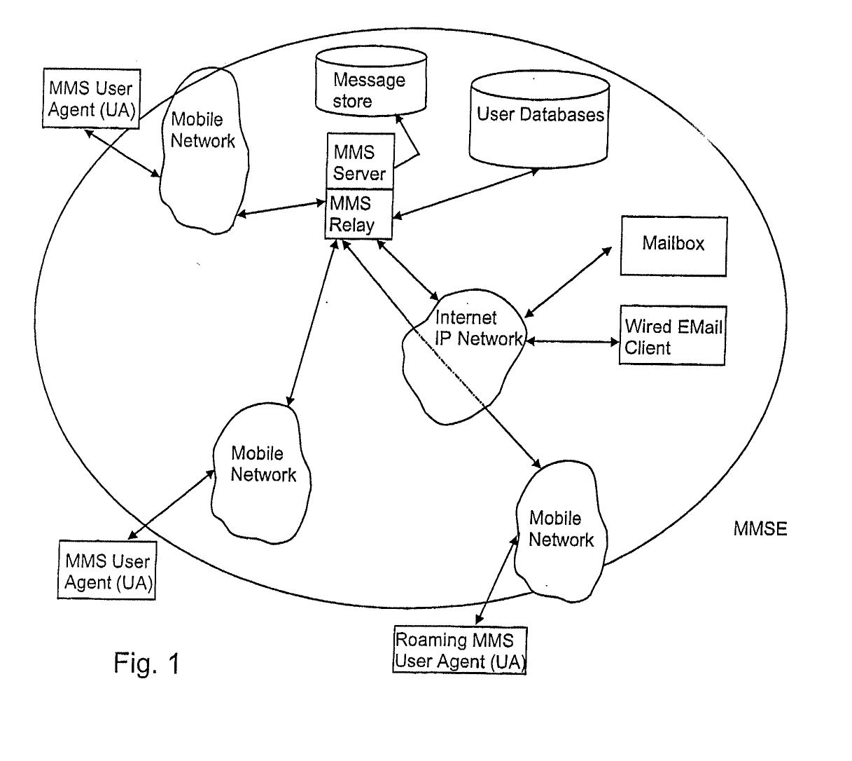

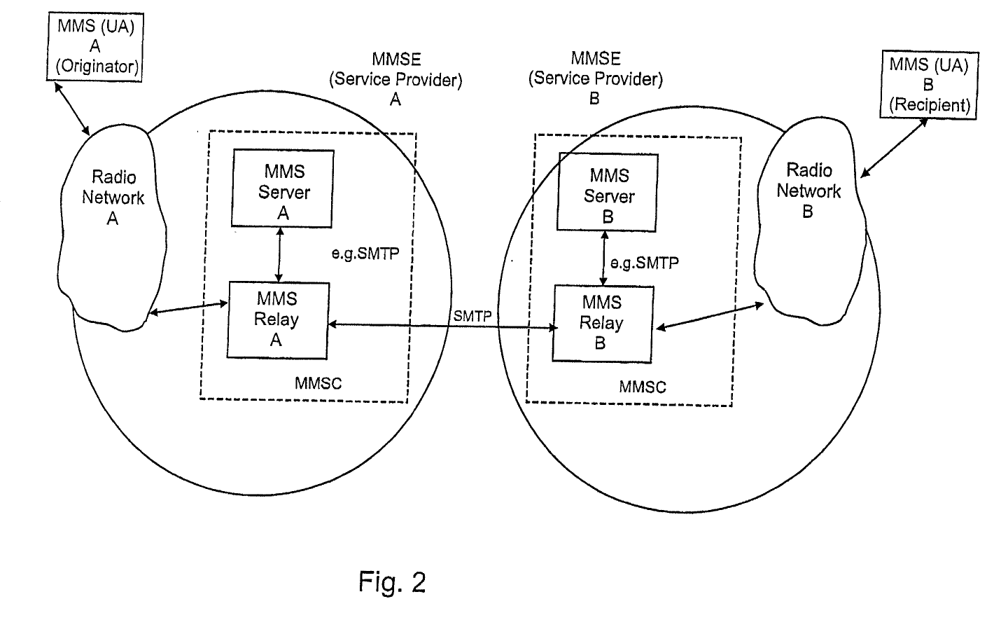

FIGS. 1 and 2 have already been described in the foregoing.

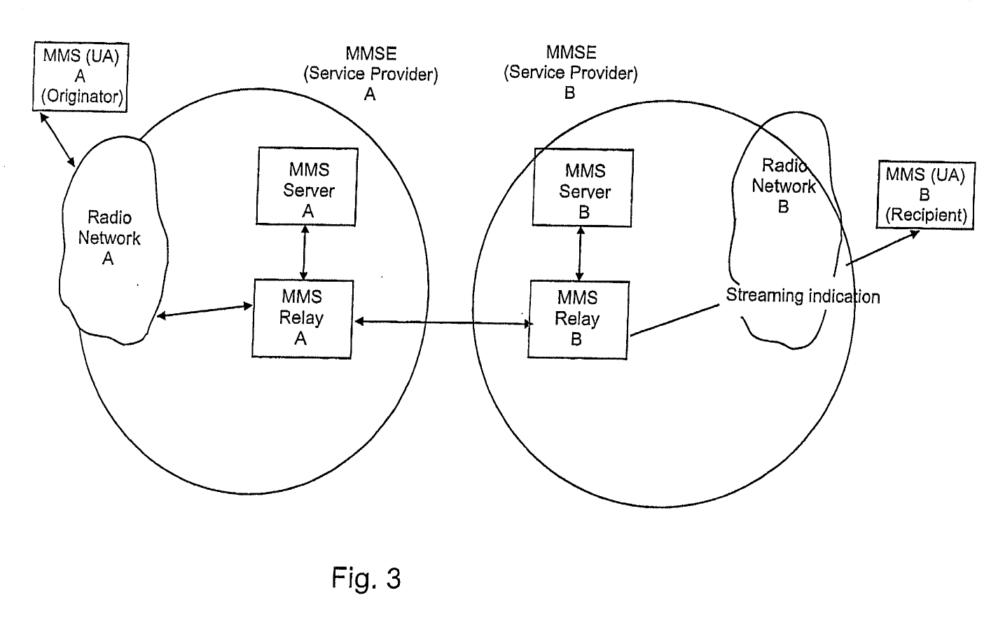

The basic concept underlying a preferred embodiment of the invention will now be described in the context of the present MMS (Multimedia Messaging Service) architecture. A preferred embodiment of the invention is illustrated in FIG. 3. FIG. 3 illustrates a general situation in which communication of multimedia messages comprising media content to be streamed takes place between MMS user agents (UAs) in two different Multimedia Messaging Service Environments. This will be referred to as the “inter-MMSE” situation. For simplicity and clarity, the two Multimedia Messaging Service Environments, MMSE A and MMSE B, are shown to comprise a single MMS relay, linked to a single MMS server. It should be appreciated that in a practical MMSE, the number of MMS relays and servers may be, and typically will be, greater than this. In the situation where a particular MMSE comprises more than one MMS relay, the method according to the invention can also be applied within the MMSE. This situation will be referred to as the “intra-MMSE” situation.

In the example shown in FIG. 3, both MMS user agents are depicted as devices that communicate with their respective MMSE via a radio communication network. It should be appreciated that either MMSE user agent A or MMSE user agent B, or both of them, could reside in a fixed line network.

In connection with FIG. 3, it will be assumed that MMS user agent A, which has subscribed to the multimedia messaging service provided in Multimedia Messaging Service Environment A, wishes to send some media content to MMS user agent B, which has a subscription to the multimedia messaging service provided in MMSE B. It will further be assumed that MMS user agent A and MMS user agent B both have subscription options with their respective MMS providers that allow media content to be downloaded either without streaming, or by streaming according to the method of the present invention. It should be appreciated that MMSE A and MMSE B may, for example, have different operators, different geographical locations or coverage areas and/or differ in terms of their technical characteristics and capabilities.

When initiating the communication of a multimedia message to MMS user agent B, MMS user agent A first selects the media content to be transmitted. For example, the media content may take the form of a video clip and an associated audio track, stored in the memory of MMS user agent A. The clip may have been recorded, for example, using a camera, video/audio capture and encoding equipment built into MMS user agent A. Alternatively, the clip may already have been downloaded from another source to MMS user agent A. In either case, MMS user agent A encapsulates the media content as a multimedia message, comprising the media content itself, information necessary to describe the media content and addressing information, identifying the intended recipient of the message. MMS user agent A then sends the message to MMS relay A through MNW A. In an alternative embodiment of the invention, the clip may be transmitted while it is being captured. In this case it cannot be encapsulated into a multimedia message.

In general, the content of a multimedia message can comprise a variety of components, some of which are suitable for streaming, such as the video clip mentioned above, and other components which are not typically suitable for streaming.

Referring once more to the example depicted in FIG. 3, on receiving the multimedia message, MMS relay A determines, from the addressing information included with the message, that the intended recipient is not an MMS user agent of MMSE A but an MMS user agent of MMS relay B and forwards the multimedia message to MMS relay B. Routing of the multimedia message to the correct MMS relay, i.e. that responsible for MMS user Agent B is achieved, for example, using standardised mechanisms provided for in the existing 3GPP multimedia messaging solution. According to 3GPP technical specification 23.140 V.3.0.1., the MMS shall support the use of E-Mail addresses or mobile subscriber international standard directory numbers (MSISDN) to address the recipient of a multimedia message. In the case of E-Mail addresses standard internet message routing should be used.

On receiving the multimedia message, MMS relay B stores the media content in MMS server B and sends a notification to the intended recipient, MMS user agent B, thereby indicating that a multimedia message has arrived and its content is available to be downloaded from MMS relay B. In response to receiving the notification, MMS user Agent B retrieves the media content from (via) the MMS relay B. The retrieval of the media content is initiated by signalling with MMS relay B.

One should bear in mind that the multimedia message is typically encapsulated, but, according to the invention, any media content it contains that is suitable for streaming can be streamed to the intended recipient from the MMSC. The content can be up loaded to the MMSC either according to the existing MMS solution or by streaming. In the preferred embodiment of the present invention, use of streaming in downloading media content to a given recipient(s) is independent of the manner in which the content was up loaded to the MMS relay.

As was previously mentioned, MMS relay B sends a notification (e.g. a message) to the intended recipient, MMS user agent B. Formation of the notification will now be examined in more detail.

Since the media content contained in a particular multimedia message is stored in MMS server B and the storing operation is performed via MMS relay B, MMS relay B has access to information describing the media content which, for example, was encapsulated with the multimedia message sent from MMS user agent A. MMS relay B is also aware of the properties and behaviour of MMSE B as, according to currently agreed recommendations covering the implementation of the multimedia messaging service in 3rd generation networks, MMS relay B is considered to be the control point for MMSE B. This also means that MMS relay B has access to information describing the configuration and capabilities of MMS user Agent B which, as described in connection with FIG. 1, is stored in a database linked to the relay. MMS relay B is further aware of its own capabilities to convert between different media types and/or formats. Thus, MMS relay B can determine, among other things:

a) whether a particular multimedia message comprises media content suitable for streaming;

b) which media content is to be streamed to MMS user agent B;

c) whether MMS user agent B is capable of receiving and reproducing the media content to be streamed;

d) whether the media content to be streamed requires translation in order to make it compatible with the capabilities of MMS user agent B;

e) whether that translation can be affected; and

f) whether MMSE B is capable of supporting streaming download of the content.

Therefore, the method according to this embodiment of the present invention proposes that the MMS relay serving/responsible for the MMS user agent that is the intended recipient of streamed media content is responsible for forming a notification (message) for informing the intended recipient of the media content to be streamed. In the following this will be referred to as a “streaming notification”.

Choice of the media content to be streamed can be performed by the MMS relay, for example, with reference to the static configuration of the MMS relay/server. Factors such as the type of media content, its format, the size of the content, its originator, the subscription options, or user-agreement of the intended recipient and many other factors, can be used by the MMS relay in order to determine which media content is suitable for streaming to the intended recipient. The factors to be considered can be defined while configuring MMS server/relay. A more advanced approach, in which a static/dynamic user profile is maintained is also possible in this regard, as is dynamic capability negotiation. Both of these latter options would allow the user or an MMS user agent to dynamically change the selection of media content for streaming.

The MMS relay provides at least a minimum required amount of information in the notification, so that the recipient MMS user agent can invoke a streaming process. This minimum amount of information typically includes, but is not limited to, the streaming protocol to be used (this in itself could be used as an indication that certain media content is to be streamed), the network address from which the content is to be streamed and the address of the content itself. A Universal Resource Identifier (URI) can carry all this information. Furthermore, the notification message defined in currently agreed specifications relating to the Multimedia Messaging Service for 3rd Generation mobile networks, has scope to carry information in the form of a URI, and thus provides immediate support for the streaming notification according to the present invention. Thus, according to an embodiment of the invention, the streaming notification is provided in the form of a URI, in a notification message compliant with agreed multimedia messaging specifications. Using such an approach, a recipient MMS user agent that receives a notification comprising a URI that contains an indication of a streaming protocol, the address of a server and the address of a certain media content, has sufficient information to initiate a streaming process with the server using the mentioned streaming protocol to retrieve the mentioned content.

It should be appreciated that, according to the invention, the streaming process can be accomplished directly between a recipient MMS user agent and an MMS server, while the MMS relay has overall control of the situation. In an alternative embodiment of the invention, the MMS relay (i.e. MMS relay B in the example shown in FIG. 3) mentions its address in the URI transmitted to the recipient MMS user agent in the streaming notification, thus enabling it to function as an intermediary between the MMS user agent and the MMS server while the content is being streamed. In this way, the MMS relay has more control over the streaming. In a further alternative embodiment of the invention, the MMS relay mentions the address of another associated streaming-capable server (e.g. a media server, streaming server of another service provider, or a server of a content provider) in the URI. In this way, different service providers (MMS, streaming, content provider) can provide services to a user provided that there is a suitable agreement between them. This also provides scope for an MMS service provider to implement a different server for streaming purposes.

According to the existing streaming session protocol, e.g. the DESCRIBE method in RTSP, there is scope for a client (e.g. MMS user agent B, in this case) to be provided with information about the media content to be streamed in the form of a so-called “presentation description”. Generally, this information is used, for example, for media initialisation before starting the streaming session. Thus, in an alternative embodiment of the invention, the notification sent from the MMS relay to the intended recipient comprises more than the absolute minimum of information required to enable the establishment of a streaming session.

According to a further alternative embodiment of the invention, the streaming notification is defined in such a way as to carry all required information (presentation description) to establish a streaming session with the intended recipient MMS user agent. This information, includes, for example, the access mechanism to be used, session protocol, transport protocol, network address and media type information, as well as details of the media codec/format, encoding used. In this way, the recipient MMS user agent is provided with all information to start a streaming session right away. However, as currently specified, the existing MMS notification message is not able to carry all this information. Therefore, in order to allow adoption of this alternative embodiment of the invention, it is proposed to include an optional information element content and content type in the existing MMS notification message. For example, a Session Description Protocol (SDP) document, could be used to provide the presentation description. The content type for this SDP document would be MIME. SDP is one standard way of providing a presentation/session description. SDP is described in more depth in the document: “Network Working Group Request for Comments #2327”, April 1998, by M. Handley and V. Jacobson. Other standard or proprietary documents can serve a similar purpose in this regard.

In summary, in a preferred embodiment of the invention a recipient MMS relay generates a streaming notification and sends it to the recipient MMS user agent. The recipient MMS relay is a network entity that is well aware of the capabilities and configuration of all associated MMS user agents and the local MMSE as a whole. The recipient MMS relay further has access to all required information about media content stored in any associated server. Hence, the recipient MMS relay is an entity well placed to gather and assimilate all necessary information for generating the streaming notification in such a way that it accurately describes the media content to be streamed, thereby enabling the MMS user agent to invoke a streaming process to download specific media content in an effective manner, at the right time and cost-effectively.

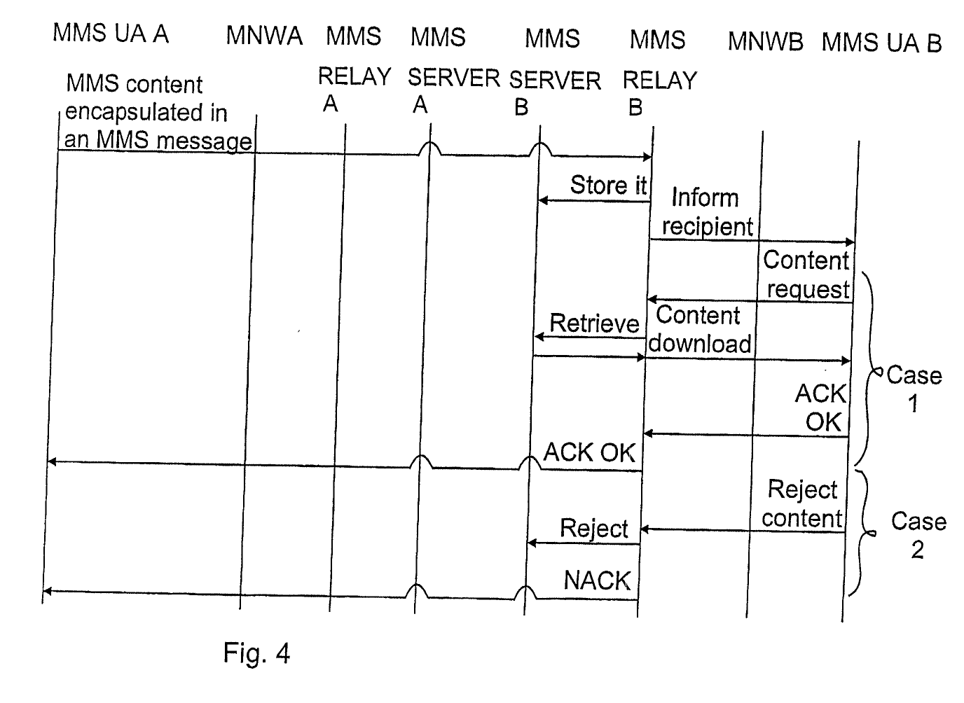

FIG. 4 presents an example of signalling that takes place in the system of FIG. 3 when media content is transmitted from MMS user agent A to MMS user agent B. The media content is first encapsulated into a multimedia message at the sender, MMS user agent A. The data message is addressed to at least one recipient (e.g. MMS user agent B). Then, MMS user agent A sends the multimedia message to the MMS relay B, the message being routed through the first telecommunication network MNW A and MMS relay A, as appropriate. When the multimedia message arrives at MMS relay B, MMS relay B sends the media content to MMS server B, where it is temporarily stored and notifies the recipient(s), in this case MMS user agent B, that media content is available for downloading by sending a notification. After having received the notification of available media content, MMS user agent B either prompts its user for acceptance to download the content, or operates according to predetermined instruction(s). There are two cases: In case 1, the content is downloaded and in case 2, the content is rejected. in an embodiment of the invention in which a standard MMS notification is used, the notification may comprise one notification of content to be downloaded by streaming and another notification of other content that cannot be streamed.

In case 1, MMS user agent B sends a content request to MMS relay B, when the content is to be downloaded (not necessarily immediately, but according to the liking of the user). The MMS relay B sends a retrieval message to the MMS server. In response to the retrieval message, the MMS server starts sending the media content to MMS user agent B through MMS relay B. After sending of the content to the MMS user agent B has been completed, MMS user agent B sends an acknowledgement to MMS relay B, to indicate that the content has been received. MMS relay B sends a further acknowledgement to the sender, MMS user agent A, if a read receipt has been requested or is provided by default. Typically, the retrieval message contains the address of the recipient(s) and, for example, the MMS server maintains a list of recipients who have not yet received the media content. Using the list, the MMS server can determine when the content is delivered to all the recipients, so that it can erase the content after it is transmitted to all its recipients. In this way, the MMS server can enhance the management of its storage capacity.

In case 2, MMS user agent B sends a reject content message to MMS relay B. MMS relay B informs the MMS server B of the recipient's decision to reject the content. Typically, it also identifies the recipient that rejected the content so that MMS server B can update the list of recipients correspondingly. MMS relay B sends a negative acknowledgement (NACK) to the sender, MMS user agent A, if a read receipt is requested or provided by default.

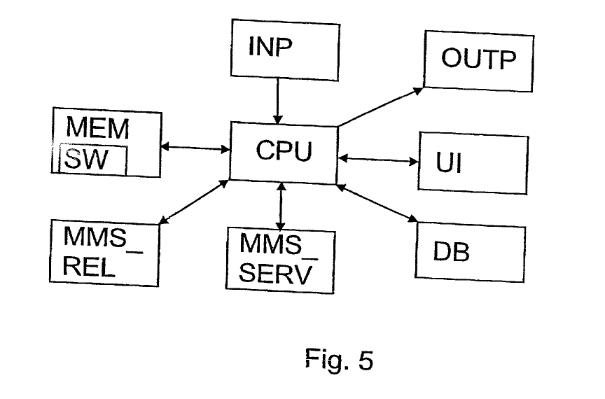

FIG. 5 shows a block diagram of a Multimedia Service Centre MMSC. The MMSC comprises an input INP, output OUTP, user interface UI, database DB, MMS Server MMS_SERV, MMS Relay MMS_REL and memory MEM comprising software (operating system and applications including an MMS application). The user interface is provided for maintenance and installation of the MMSC. The memory typically comprises both random access memory (working memory for the CPU) and one or more mass memories (for maintaining the operating system and applications as computer program code executable by the CPU). The input receives MMS messages from a sender and notifications from the recipient. The output is used for providing the media content to the recipient and for providing notifications to the recipient and sender.

The various embodiments of the present invention solve or mitigate a number of problems associated with prior art. Firstly, the method according to the invention enables streaming of media content to be incorporated into a multimedia messaging system in a manner that is compatible with already existing MMS specifications. More specifically, according to certain embodiments of the invention, the streaming notification sent from a recipient MMS relay to a recipient MMS user agent can be implemented using a standard MMS notification message. Furthermore, basic information about the media content to be streamed and the streaming session to be formed can be provided in the notification message using existing information elements. Additional information can be incorporated by making relatively simple changes to the kind of data that can be provided in the existing MMS notification message. This capacity for “backward compatibility” is extremely advantageous, enabling streaming to be incorporated in a multimedia messaging system without requiring extensive modifications to existing recommendations.

The present invention also has advantages compared with the method for incorporating streaming into a multimedia messaging system proposed by Finnish patent application Fl 2000 1741. Specifically, in a system such as that proposed by Fl 2000 1741, in which a notification is sent from a sending MMS user agent to a recipient MMS user agent in order to provide the recipient with information necessary to establish a streaming session, the sending MMS user agent is generally unaware of the capabilities, configuration and/or subscription options of the recipient UA. This may give rise to a situation in which the sending MMS user agent provides the recipient with inappropriate information, or suggests the streaming of media content which the recipient cannot handle. Similarly, if the sending MMS user agent and the recipient MMS user agent reside in different MMSEs, the sending MMS user agent is not aware of the capabilities, technical features and/or behaviour of the MMSE in which the intended recipient is resident. Thus, in a system such as that proposed in Fl 2000 1741, this may also lead to a situation in which the sending MMS user agent provides the recipient with a notification comprising inappropriate information, or may suggest the streaming of media content which the recipient's MMSE cannot handle. The provision of end-to-end notification messages, as suggested in Fl 2000 1741 may also lead to inefficient use of the available radio resources and excessive traffic.

The method proposed according to the present invention, in which the MMS relay that serves/is responsible for the recipient MMS user agent, forms a streaming notification, overcomes the aforementioned problems. Specifically, a streaming notification generated at the recipient MMS relay can take into account the configuration, capabilities and e.g. subscription options of the recipient MMS user agent. Furthermore, in situations where media content is translated from one format/type into another, e.g. at the recipient MMS relay, the method according to the present invention enables more accurate content-specific information to be provided in the streaming notification. Similarly, information provided in the streaming notification can more accurately reflect the configuration and characteristics of the local MMSE. This is particularly important in a situation where the sending MMS user agent resides in one MMSE and the recipient MMS user agent resides in another MMSE (inter-MMSE case). However, a similar advantage may also arise in an intra-MMSE situation, where e.g. different parts of a single MMSE have different configurations, characteristics or capabilities. The method according to the invention also enables a “local” decision to be taken about the media content to be streamed, e.g. in such a way that dynamic factors such as the current traffic situation, load or availability of MMS system or network resources (e.g. storage or processing capacity) can be taken into account when forming a streaming notification. In other words, decisions e.g. about which content to stream and in what format it should be streamed can be performed in the MMSE (or part thereof) in which the intended recipient is resident. All of the features mentioned above lead to an improved probability that the streaming of media content can be performed successfully and in an efficient manner.

It is a further advantage of the present invention that the streaming download of media content to the recipient MMS user agent is independent of the method by which the media content is uploaded. This allows different and flexible implementations at the sending and receiving ends, both in the MMSE(s) and at the sending and recipient MMS user agents. As end-to-end notification is not provided, radio and network resources is also used more efficiently.

Particular implementations and embodiments of the invention have been described. It is clear to a person skilled in the art that the invention is not restricted to details of the embodiments presented above, but that it can be implemented in other embodiments using equivalent means without deviating from the characteristics of the invention. The scope of the invention is only restricted by the attached patent claims.

What is claimed is:

1. A method in a network entity comprising the steps of:
receiving media content from a sending entity and addressed to at least one recipient;
accessing a database comprising recipient data describing multimedia reception capabilities and/or reception preferences for at least one recipient;
forming, in accordance with said recipient data, a notification message containing information that said media content is available to be streamed to said at least one addressed recipient; and
outputting the notification message for transmission to said at least one addressed recipient.

2. A method according to claim 1 further comprising the steps of:
receiving the media content in a multimedia messaging server; and
providing the at least one addressed recipient with the media content via the network entity;
wherein the network entity is a multimedia messaging relay.

3. A method according to claim 1, wherein a streaming session is established in order to stream at least some of the media content to said at least one recipient.

4. A method according claim 3, wherein said establishing of a streamed session is preceded by transmitting the notification message to said at least one addressed recipient.

5. A method according to claim 1, wherein the media content comprises a set of different types of components and each component can be formatted in one or more formats.

6. A method according to claim 5, wherein the method further comprises the following steps before said outputting of the media content:
checking the format of at least one component of the received media content;
determining by using the recipient data whether the format is appropriate for said at least one addressed recipient; and
if necessary, translating the component into a format appropriate for said at least one addressed recipient.

7. A method according to claim 1, wherein said notification message provides a minimum amount of information necessary for said at least one addressed recipient to establish a streaming session with the said network entity.

8. A method according to claim 1, wherein the method further comprises providing a radio link during communication with the addressed recipient.

9. A method according to claim 1, wherein said sending entity is chosen from a group consisting of: a media storing entity of a first telecommunication network, a media storing entity of a second telecommunication network, a media storage in an external data transmission network, and a terminal of the first telecommunication network.

10. A method according to claim 9, wherein the method further comprises transmitting the notification message to said at least one addressed recipient via a first telecommunication network and forming said notification message taking into account the properties of the first telecommunication network.

11. A network entity comprising:
means for receiving a media content from a sending entity and addressed to at least one recipient;
means for accessing a database comprising recipient data describing multimedia reception capabilities and/or reception preferences for the at least one addressed recipient;
notification means for forming, in accordance with said recipient data, a notification message containing information that said media content is available to be streamed to said at least one addressed recipient; and
outputting means for outputting the notification message for transmission to said at least one addressed recipient.

12. A communication system, comprising:
at least one recipient;
a network entity;
means for receiving media content from a sending entity and addressed to said at least one recipient;
means for accessing a database comprising recipient data describing multimedia reception capabilities and/or reception preferences for the at least one addressed recipient;
notification means for forming, in accordance with said recipient data, a notification message containing information that said media content is available to be streamed to said at least one addressed recipient; and
outputting means for outputting the notification message for transmission to said at least one addressed recipient.

13. A computer program for controlling a network entity, comprising:
computer code for causing the network entity to receive media content from a sending entity and addressed to at least one recipient;
computer code for causing the network entity to access a database comprising recipient data describing multimedia reception capabilities and/or reception preferences for the at least one addressed recipient;
computer code for causing the network entity to form, in accordance with said recipient data, a notification message containing information that said media content is available to be streamed to said at least one addressed recipient; and
computer code for causing the network entity to output the notification message for transmission to said at least one addressed recipient.
